(19) United States
(12) Patent Application Publication
(10) Pub. No.: US 2020/0349652 A1
(43) Pub. Date: Nov. 5, 2020

(54) SYSTEM TO SIMULATE OUTCOMES OF A NEW CONTRACT WITH A FINANCIER OF CARE

(71) Applicant: KONINKLIJKE PHILIPS N.V., Eindhoven (NL)

(72) Inventors: Ricardo Alfredo QUINTANO NEIRA, Eindhoven (NL); Jennifer CAFFAREL, Eindhoven (NL); Ioanna SOKORELI, Eindhoven (NL)

(21) Appl. No.: 16/865,071

(22) Filed: May 1, 2020

Related U.S. Application Data
(60) Provisional application No. 62/842,766, filed on May 3, 2019.

(51) Int. Cl. G06Q 40/08; G06F 30/20

(52) U.S. Cl. CPC G06Q 40/08; G06F 30/20

(57) ABSTRACT

A method for managing healthcare information includes selecting a type of outcome under a payer contract with a healthcare organization (HCO), generating a set of similar populations based on information including HCO data, calculating outcomes for the similar populations in the set based on terms and conditions of the payer contract, calculating performance measures for the calculated outcomes, and outputting the performance measure with the calculated outcomes to identify a best outcome under the payer contract for one or more parameters. The outcomes may be calculated based on a simulation algorithm.

### CROSS-REFERENCE TO PRIOR APPLICATIONS

This application claims the benefit of U.S. Provisional Application No. 62/842,766, filed on 3 May 2019. This application is hereby incorporated by reference herein.

### TECHNICAL FIELD

This disclosure relates generally to processing information, and more specifically, but not exclusively, to managing the allocation and cost of providing healthcare resources.

### BACKGROUND

Healthcare organizations (HCOs) face a panoply of challenges in trying to balance the allocation of healthcare resources against ever-rising cost considerations. One particular challenge involves an inability to determine with a reliable degree of accuracy the impact of entering into new contracts with payers. The contracts often involve health plans and related health insurance which, if not properly negotiated, could adversely affect the financial well-being of HCOs, which, in turn, may place limitations on the quality and availability of care to patients.

Often times, contracts call for the payment of value-based care based on quality indicators assessed at the population level. Examples of quality indicators include reduction in treatment time, reduction in hospitalizations, and patient satisfaction. Invariably, HCOs have difficulty predicting how care and costs should be allocated to meet their objectives, especially during negotiation of a new contract with a payer. The unknowns and faulty assumptions made by HCOs are magnified, for example, when attempting to make decisions for new populations, reimbursement policies, and available services.

Because negotiating payer contracts directly bears upon quality of care, the ability to analyze information and accurately determine probable outcomes using simulation algorithms would provide a solution to helping HCOs negotiate payer contracts.

### SUMMARY

A brief summary of various example embodiments is presented below. Some simplifications and omissions may be made in the following summary, which is intended to highlight and introduce some aspects of the various example embodiments, but not to limit the scope of the invention. Detailed descriptions of example embodiments adequate to allow those of ordinary skill in the art to make and use the inventive concepts will follow in later sections.

In accordance with one or more embodiments, a method for managing healthcare information includes selecting a type of outcome under a payer contract with a healthcare organization (HCO); generating a set of similar populations based on information including HCO data; calculating outcomes for the similar populations in the set based on terms and conditions of the payer contract, the outcomes calculated using a simulation algorithm; calculating performance measures for the calculated outcomes; and outputting the performance measure with the calculated outcomes to identify a best outcome under the payer contract for one or more parameters.

Generating the set of similar populations may include filtering and pre-processing the HCO data and randomly selecting HCO patients until one or more constraints (e.g., % per age group, % per chronic disease) of a payer population are satisfied. The method may include defining parameters for the simulation algorithm used to calculate the outcomes. The type of outcome may be one of case cost, case duration, reimbursement, cost per disease, and quality KPIs.

The method may include filtering the HCO data prior to generating the set of similar populations, wherein the HCO data is included in categories which include patient data, encounter data, and encounter items. The method may include performing a multivariable regression analysis based on at least one independent variable and at least one dependent variable, wherein results of the multivariable regression analysis indicates one or more attributes that contributed to a worst one of the calculated outcomes. The method may include relating simulated quality outcomes to expected values in the contract. The method may include calculating invisible extra costs for a plurality of episodes of care. The method may include generating graphical representations of the outcomes; and displaying the graphical representations. The method may include receiving the information of the proposed payer contract and the HCO data through different fields of a screen displayed on a graphical user interface.

In accordance with one or more embodiments, a system for managing healthcare information includes a storage device to store instructions; and an analysis engine configured to simulate performance under a payer contract with a healthcare organization (HCO). The analysis engine executes the instructions to select a type of outcome to be evaluated under the payer contract; generate a set of similar populations based on information including HCO data; calculate outcomes for the similar populations in the set based on terms and conditions of the payer contract, the outcomes calculated using a simulation algorithm; calculate performance measures for the calculated outcomes; and output the performance measure with the calculated outcomes to identify a best outcome under the payer contract for one or more parameters.

The analysis engine may perform the following in order to generate the set of similar populations: filtering and pre-processing the HCO data and randomly selecting HCO patients until one or more constraints (e.g., % per age group, % per chronic disease) of a payer population are satisfied. The analysis engine may define parameters for the simulation algorithm used to calculate the outcomes. The type of outcome may be one of case cost, case duration, reimbursement, cost per disease, and quality KPIs.

The analysis engine may filter the HCO data before the set of similar populations are generated, and wherein the HCO data is included in categories which include patient data, encounter data, and encounter items. The analysis engine may perform a multivariable regression analysis based on at least one independent variable and at least one dependent variable, and wherein results of the multivariable regression analysis indicates one or more attributes that contributed to a worst one of the calculated outcomes. The analysis engine may calculate invisible extra costs for a plurality of episodes of care. The analysis engine may generate graphical representations of the outcomes and display the representations.

### BRIEF DESCRIPTION OF THE DRAWINGS

The accompanying figures, where like reference numerals refer to identical or functionally similar elements throughout the separate views, together with the description below, are incorporated in and form part of the specification, and serve to further illustrate example embodiments of concepts found in the claims and explain various principles and advantages of those embodiments.

These and other more detailed and specific features are more fully disclosed in the following specification, reference being had to the accompanying drawings, in which:

FIG. 1 illustrates an embodiment of a system for managing healthcare costs and services;

FIG. 2 illustrates an embodiment of a method for managing healthcare costs and services;

FIGS. 3A and 3B illustrate examples of a graphical user interface for inputting information;

FIG. 4 illustrates an example of a graphical user interface for inputting information;

FIG. 5 illustrates an example of a graphical user interface for outputs analysis results;

FIG. 6 illustrates an embodiment of a system for managing healthcare costs and services;

FIG. 7 illustrates an example of tables that may be stored in a database;

FIG. 8 illustrates an example of category information stored in a database;

FIGS. 9A to 9M illustrate examples of use cases for implementing the method embodiment(s); and

FIG. 10 illustrates an example of a system for managing healthcare information.

### DETAILED DESCRIPTION

It should be understood that the figures are merely schematic and are not drawn to scale. Same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various example embodiments described herein are not necessarily mutually exclusive, as some example embodiments can be combined with one or more other example embodiments to form new example embodiments. Descriptors such as “first,” “second,” “third,” etc., are not meant to limit the order of elements discussed, are used to distinguish one element from the next, and are generally interchangeable. Values such as maximum or minimum may be predetermined and set to different values based on the application.

Example embodiments describe a system and method for managing healthcare costs and services. In one embodiment, simulation algorithms are used to analyze benefits and disadvantages associated with new contracts between healthcare organizations (HCOs) and payers. The analysis may take into consideration relevant factors (e.g., population, costs, available services, etc.) and generate corresponding outcomes. The factors may be changed to generate new outcomes and to anticipate various cost and service scenarios. In one embodiment, the system and method may perform simulations on already available data to assess the likelihood that an HCO could achieve predetermined targets given the terms of a proposed payer contract. The outcomes and other results of the analysis may therefore serve as an essential tool in guiding strategic decision makers (SDMs) of HCOs during contract negotiations with payers.

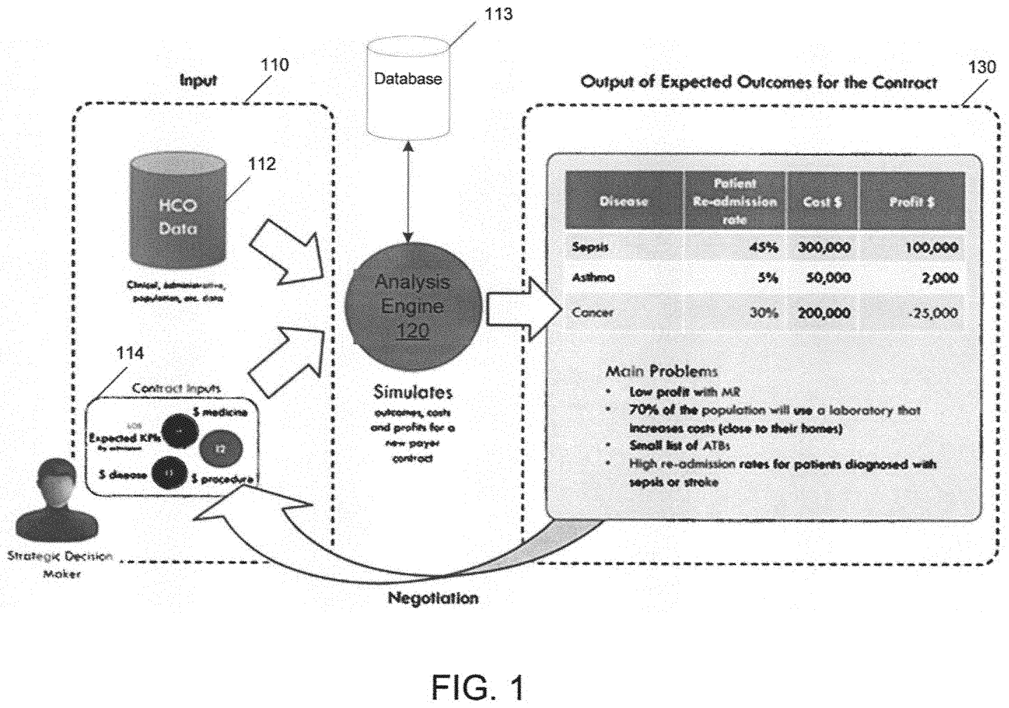

FIG. 1 illustrates processing stages that may be implemented for one embodiment of a system 100 for managing healthcare costs and services in relation to a new contract with a payer. The payer may be an existing payer for an HCO, in which case the contract would be a new or renegotiated contract with the same payer. Alternatively, the payer may be a new payer entering into a new contract with the HCO.

Referring to FIG. 1, the processing stages include an input stage 110, an analysis stage (or engine) 120, and an output stage 130. The input stage 110 includes a database 112 and a module 114. The database 112 stores information relating to an HCO which is considering entering into the new contract. The information includes clinical, administration, and population data and/or other information. This information is retrospective or historical in nature, indicative of financial policies and practices, cost allocations, episodes of care, treatment plans, and/or other data that provides an accurate reflection of the cost and care structure of the HCO.

The module 114 receives inputs, for example, from an SDM of the HCO indicating the terms and conditions of the proposed contract. The terms may include, for example, payer population characteristics, reimbursement values per episode of care, types and costs of medicines, procedural information (e.g., affecting clinical services, insurance coverage and policies, etc.), expected key performance indicators (KPIs) such as re-admissions, and types and costs of treating various diseases. The module 114 may include a processing terminal for receiving and storing this information (e.g., internally or in database 112) and uploading or otherwise transferring this information to the analysis stage 120.

The analysis stage (or analysis engine) 120 implements simulation algorithms to generate outcomes (e.g., patient outcomes, costs, profits, etc.) that may be expected under the proposed contract. The outcomes may provide a basis for: one, helping SDMs gain a better understanding of the proposed payer contract and their implications; two, identifying areas of concern or improvement which the SDMs could not otherwise know except for the outcomes generated by the analysis engine 120; and three, assessing weak and strong points in the proposed contract from the point of view of the HCO. Ultimately, the results of the analysis engine 120 may allow for negotiating a change in terms of the proposed contract in a way that advances the care and cost objectives of the HCO, which objectives would otherwise be adversely affected if not for the outcomes and results generated by the analysis engine 120).

The analysis engine 120, as indicated above, may execute simulation algorithms to generate the outcomes based, at least in part, on the information from database 112 and module 114. In one embodiment, the analysis engine 120 may use a simulation algorithm based on a Monte Carlo method to generate a range of outcomes and their associated probabilities under the proposed payer contract for the HCO. The algorithm may use information from stage 110 as inputs in order to calculate simulated outcomes based on a number of random samplings. The accuracy of the simulated outcomes may increase as the number of random samplings increases. Examples of Monte Carlo simulations that may be used to generate the outcomes are disclosed in Law, A. M., Kelton, W. D. & Kelton, W. D., Simulation Modeling and Analysis (Vol. 2), New York, McGraw-Hill (1991), and Choi, B. K., & Kang, D., Modeling and Simulation of Discrete Event Systems, John Wiley & Sons (2013).

The analysis engine 120 may be implemented in hardware, software, or a combination of hardware and software. In addition, engine 120 may be coupled to the input stage 110 in various ways. For example, the processing terminal that stores or accesses the information of input stage 110 may also include the analysis engine 120. In another case, the input stage 110 may be coupled to a processor of the analysis engine through a remote connection, e.g., through a network such as the internet which may or may not be configured to include a cloud-type storage device and processor.

The output stage 130 outputs information indicative of the outcomes generated by the analysis engine 120. The information may be output in various ways, for example, using various custom screens, menus, graphical objects, and other visual techniques. In FIG. 1, an example of several outcomes is illustrated for a proposed payer contract. In this example, outcomes determined by the analysis engine 120 are provided for various diseases, e.g., sepsis, asthma, and cancer. The outcomes are expressed in numerical costs and percentages for patient re-admission rates, costs to the HCO in providing care, and the corresponding estimated profit to the HCO. The highest cost and most profitable case is for sepsis, with a 45% re-admission rate. The case for asthma was substantially less in terms of cost, profit, and re-admission rate. By far, the most concerning case was for cancer, where no profit, and in fact a loss, was projected for substantial cost and re-admission rate.

A number of additional outcomes may also be output. For example, the results from the output stage 130 include an indication of main problems that might be expected under the proposed contract. The main problems indicate a low profit expectation for magnetic resonance imaging (MRI), an estimate that 70% of the population will use a laboratory that increases costs (close to their homes), a relatively small list of antibiotics (ATBs), and high re-admission rates for patients diagnosed with sepsis or stroke.

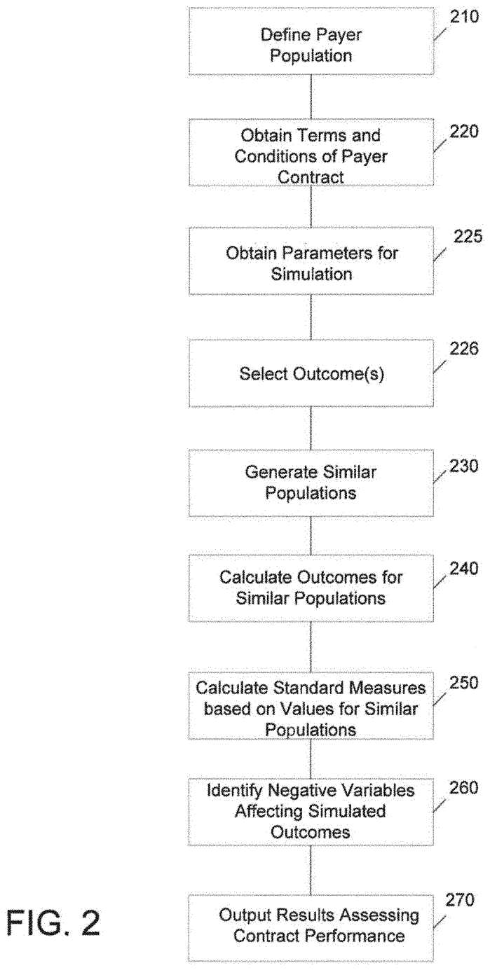

FIG. 2 illustrates an embodiment of a method for managing healthcare costs and services in relation to a new contract with a payer. The method may be performed, in whole or part, by the system of FIG. 1 or by a different system. In operation 210, a payer population for the proposed contract is defined based on information stored in module 114 of the input stage 110. This information may be provided, for example, from an SDM or may be received from one or more databases coupled to the system, for example, through a network.

The payer population may be indicated, for example, based on the data manually provided by the payer or automatically collected from a PHM system. The payer population definition may serve as input in a subsequent operation for creating or otherwise identifying similar populations using HCO available data. An example of similar populations is discussed in greater detail below.

In one embodiment, information for defining the payer population may be stored in the input stage 110. This information may include one or more of a) the percentage of the relevant population with a given chronic disease (e.g., 8% of the payer population has Type 2 diabetes), the percentage of the population per age group and gender, the percentage of the population determined based on locality (e.g., district, city, county, state, etc.), and the total expected number of beneficiaries of the payer. This information may vary, for example, depending on the contract terms and conditions (e.g., a contract may cover a whole population of patients insured or may cover a more specific subset of the insured population).

All or a portion of the information stored in input stage 110 may be received through one or more programming interfaces. One such interface is a graphical user interface having predetermined fields or windows for receiving information to be stored. Examples fields may be provided for payer population definition and terms and conditions parameters, and/or other information. The payer population definition may serve as input in operation 230.

In operation 220, the terms and condition parameters of the proposed payer contract are stored in the input stage 110, e.g., in module 114. This information may be provided, for example, from an SDM or may be received from one or more external systems (e.g., interoperability messages) or manually entered by a user. An example of the terms and condition parameters include, but are not limited to, reimbursement by episode of care (e.g. $20,000 per septic shock case), reimbursement for medicines and executed procedures, incentives related to quality indicators (e.g., bonus of 5% if the re-admission rate is smaller than 3%, or penalty of 3% if the number of avoidable ED encounters is greater than 55%), and cost per item (e.g., medicine, procedure, etc.). The particular terms and parameters may be different for different payer contracts, and thus the information to be considered is expected to vary in each particular case.

In operation 225, parameters to perform the simulation algorithm may be obtained. These parameters may be manually provided by a user and/or stored in module 114 and retrieved. Examples of the parameters are indicated below. In one embodiment, these parameters may be used in operation 230 to generate similar populations.
1. periodSimulation: Period of time to be considered in the simulation.
2. sizePopulation: Number of elements of each simulated population.
3. numberOfSimilarPopulations: Number of populations to be simulated.
4. considerFullPeriodOfChronicDisease: yes/no. If yes is selected, patients with chronic diseases treated for a period equal or greater than periodSimulation may only be considered. If no is selected, all patients with chronic diseases may be considered.

In operation 226, one or more outcomes to be evaluated in the simulation are selected or designated by a user. In one embodiment, the outcome(s) may be predetermined and/or programmed into the simulation algorithm. In one embodiment, the tool 120 or other processor of the system may provide a pre-defined list of outcomes, or types of outcomes, to be selected. Examples of outcomes that may be selected include, but are not limited to, case cost, case duration, reimbursement, cost per disease, and quality KPIs.

In operation 230, the analysis engine 120 generates a set of similar populations based on the information stored in the input stage 110. The analysis engine 120 will generate several sets of populations that are similar to the population of the payer based on the information and parameters collected from the previous operations, including the data from the HCO system (e.g., hospital information system (HIS), electronic health records (EHR), etc.). In one embodiment, each population set may be considered a similar population, and the size of each similar population may be the same number of expected beneficiaries of the payer. In one case, the similar populations may be generated using the whole population from the HCO.

When there is lack of patient data for a specific condition in the HCO data, analysis engine 120 may simulate patients and their outcomes. This may be accomplished, for example, using data derived from epidemiology reports for the same geography and/or other information. In one embodiment, the analysis engine 120 may simulate patient data based on national or regional averages and distributions for a particular condition.

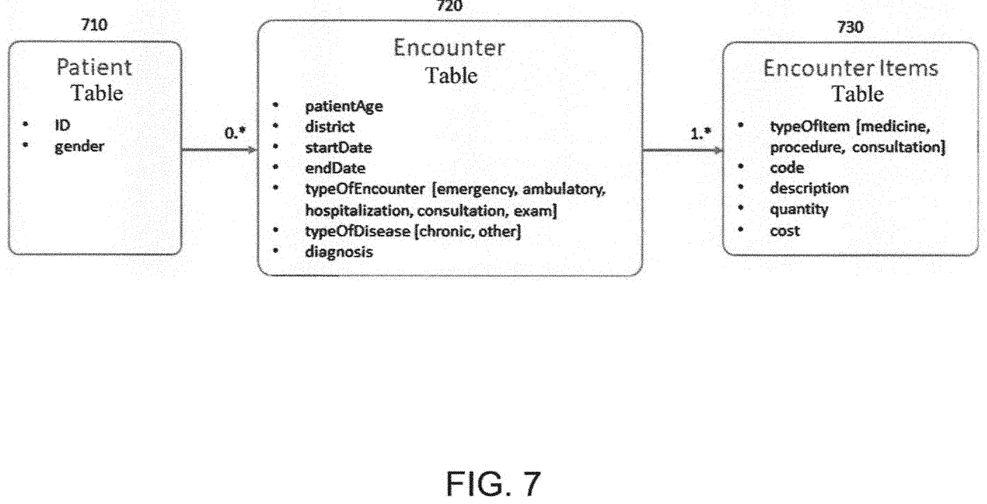

In operation 230, the analysis engine may create similar populations based on data from database 112 and input from module 114 by, first, extracting patient data from database 112 (e.g. HIS, EHR) and storing it in a database 113. In one embodiment, the database may store a plurality of tables, the contents may correspond to the examples illustrated in FIG. 7.

As illustrated in FIG. 7, the tables stored in database 113 may include:
a. Patient: This table 710 stores information regarding the patient.
b. Encounter: This table 720 stores information regarding healthcare encounters. Examples include patient age, district, start date, end date, type of encounter (e.g., emergency, ambulatory, hospitalization, consultation, exam, etc.), type of disease (e.g., chronic, other), and diagnosis. The age and district may be included in this table because these attributes may vary per encounter.
c. Encounter Items: This table 730 stores information indicative of types of payable items (e.g. consultations, procedure, medicines, etc.), code, description, quantity, cost, etc.

Second, the analysis engine 120 may remove information from database 113 (e.g., from Table 710) corresponding to patients and encounters that have patient attributes different from those specified, for example, in operation 210 (e.g. gender).

Third, the analysis engine 120 may remove encounters (e.g., from Table 720) having attributes different from those specified, for example, in operation 210 (e.g. district, age, etc.).

Fourth, the analysis engine 120 may remove information from database 113 under the following conditions. If considerFullPeriodOfChronicDisease=yes and the percentage of patients with chronic diseases is provided, remove encounters (e.g., from Table 720) of patients when treatment for chronic diseases is less than periodSimulation. For each patient indicated in (e.g., Table 710 of) database 113, the analysis engine 120 gets all encounters according to the following logic:

a. typeOfEncounter=Chronic, group by diagnosis.
i. For each patient and diagnosis (patientDiagnosis):
   1. Get dateOfFirstEncounter: startDate of the first encounter;
   2. Get dateOfLastEncounter: startDate of the last encounter;
   3. Calculate periodOfDisease=dateOfLastEncounter−dateOfFirstEncounter
   4. If periodOfDisease<periodSimulation: Remove all encounters with this specific diagnosis for that given patient.
   5. Else continue to next patientDiagnosis

Fifth, the analysis engine 120 may generate an ID for each patient. The ID may be a sequential number starting from 1.

Sixth, the analysis engine 120 may create similar populations. The number of similar populations created may be equal to numberOfSimilarPopulations. For example, for each population, the analysis engine 120 may:
a. Create a set of variables (POP_VARS) to store the number of individuals per Payer Population Characteristics (e.g., as defined in operation 210).
b. Randomly draw patients from database 113, e.g., randomly draw a number in the interval of all patient IDs and determine the identity of the patient based on the ID.
c. For each selected patient, add 1 for each Payer Population Characteristics Variable (POP_VARS) that the patient is part, e.g., if the Patient is female and has asthma, add 1 to femalePatients and Asthma POP_VARS.
d. Calculate the % per Payer Population Characteristics POP_VAR % (POP_VAR/sizePopulation*100), e.g., if femalePatient=145 and sizePopulation=1000, the % will be 14.5 (145/1000*100).
e. If all Payer Population Characteristics Variables % (POP_VAR %) that the selected patient makes part of are less or equal the Payer Population Characteristics as defined in operation 210, add the patient (and all associated encounters and encounter items) to the population. Otherwise, discard this patient and draw a new one.
f. Perform items b to e above until the current similar population is equal to sizePopulation.

If there is lack of patient data for a specific condition in the HCO data, analysis engine 120 may simulate patients and their encounters. This may be accomplished, for example, based on data derived from epidemiology reports for the same geography and/or other information. In one embodiment, the analysis engine 120 may simulate patient data based on national or regional averages and distributions for a particular condition.

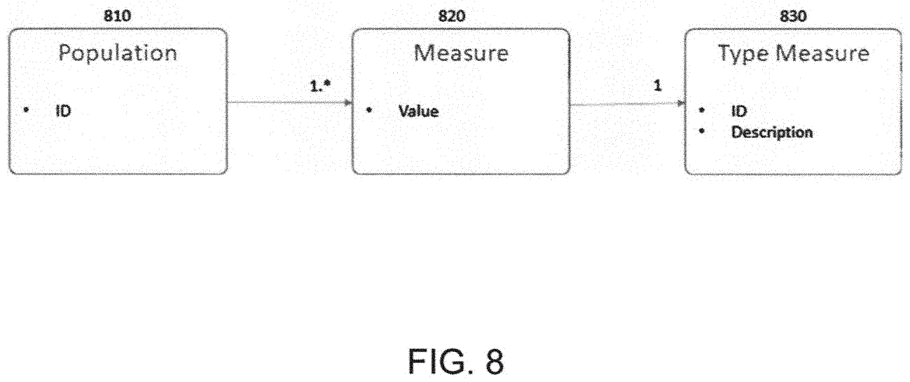

In operation 240, the analysis engine 120 calculates associated outcomes for each similar population created in operation 230. The set of outcomes may be those defined, for example, in operation 226. If a parameter for the calculation was not provided in operation 220 (e.g. medicine, procedure cost, etc.), the analysis may store information indicating the same and notify the user that the parameter should be provided. Each calculated outcome may be stored in a structure as illustrated, for example, in FIG. 8 which stores information in categories including population 810, measure 820, and type measure 830. For the calculation of some outcomes (e.g. profit or reimbursement), the analysis engine 120 may apply in the final value the incentives based on their quality measures.

In operation 250, analysis engine 120 may calculate one or more standard measures (e.g., mean, median, standard deviation, min, max, etc.) for each of the calculated outcomes, based on the parameters (e.g. costs, profits) calculated for the similar populations. Using the information in tables 820 and 830, the analysis engine may calculate the following standard measures, taking into consideration outcomes of all similar populations generated in operation 240: mean, median, minimum, maximum, standard deviation, and CI. In one embodiment, the analysis engine 120 may generate graphs (e.g., boxplot, histogram, etc.) based on the outcomes of the similar populations. For example, in one embodiment, a histogram may be generated to identify probabilities of a specific outcome occurring, e.g., a profit higher than $100,000 occurred only in 5% of simulations.

In operation 260, the analysis engine 120 may identify variables that negatively affect the simulated outcomes (e.g., in terms of care, cost, and/or profit) from the standpoint of the HCO. For example, the analysis engine 120 may create dynamic tables to store independent variables (e.g., age of patient, profit per exam, profit per medication, procedure was executed in or out the network) and dependent variables (e.g., profit, cost). Each line of the table may represent an encounter. The dependent variables may be defined in operation 226.

With these tables, the analysis engine 120 may execute a multivariate regression to identify which variables contributes to the dependent variable (e.g. total profit). The following table provides an example for performing the multivariable regression. In this example, columns A to H are the independent variables and column I is the dependent variable.

| Pa- | | | | Consul- | | Quant. | Quant. | |
|---|---|---|---|---|---|---|---|---|
| tient | | TC | RM | tation | | TC in | TC out | Total |
| Age | Diagnosis | profit | profit | profit | . . . | network | network | Profit |
| (A) | (B) | (C) | (D) | (E) | (F) | (G) | (H) | (I) |
| [symbol] | [symbol] | [symbol] | [symbol] | [symbol] | [symbol] | [symbol] | [symbol] | [symbol] |

[symbol]

indicates data missing or illegible when filed

In one embodiment, multivariable regressions may be performed using profit as a dependent variable and associated costs (e.g., medications, procedures, etc.) as independent variables. The multivariable regressions provide an indication of the main attributes that contributed to the worst outcomes. In another embodiment, one or more other variables may be used to perform the multivariable regressions, e.g., adherence to available treatments in the healthcare organization network and patient age may be used as independent variables.

The analysis engine 120 may also identify what may be referred to as “invisible extra costs” for episodes of care. For example, elderly patients who have recovered from sepsis have higher probability of visiting a psychologist due to depression or anxiety. For each of the diseases presented in the similar populations, the analysis engine 120 may calculate the percentage of other diseases, e.g. of 1,500 patients who had sepsis, 345 (21%) had depression and 345 (15%) had anxiety. With the analysis of these percentages, the “invisible extra costs” may be determined.

In addition to the aforementioned operations, the analysis engine 120 may identify and highlight Quality KPIs values (e.g. emergency encounters rate, re-admission rate) with simulated outcomes values that generate penalties or withhold bonuses (e.g., by comparing the median value calculated in operation 250 with one or more parameters provided in operation 220). Additionally, or alternatively, the analysis engine 120 may relate simulated quality outcomes (e.g., KPIs) to expected values in the contract. In one embodiment, KPIs that do not meet an associated range defined in the contract may be highlighted or otherwise emphasized for recognition in the output results.

The analysis engine 120 may also calculate what may be referred to as “invisible extra costs” for episodes of care. For example, elderly patients who have recovered from sepsis have higher probability of visiting a psychologist due to depression or anxiety. There are many types of invisible (or hidden or ancillary) extra costs, some of which may be determined, for example, based on epidemiology reports and/or other information. The analysis engine 120 may be programmed to generate output indicative of invisible extra costs in connection with a proposed payer contract.

In operation 270, the output stage 130 outputs the outcomes (e.g., from operations 250 and 260) generated by the analysis engine 120 to a user, along with other results generated from the analysis engine 120. The results may be reviewed, for example, by one or more SDMs for purposes of assisting in negotiating the contract with the payer. The output stage 130 may output the results in a variety of ways. For example, the results may include expected costs, profit, and/or clinical quality measures per disease, per contract KPI, or globally considering the whole contract.

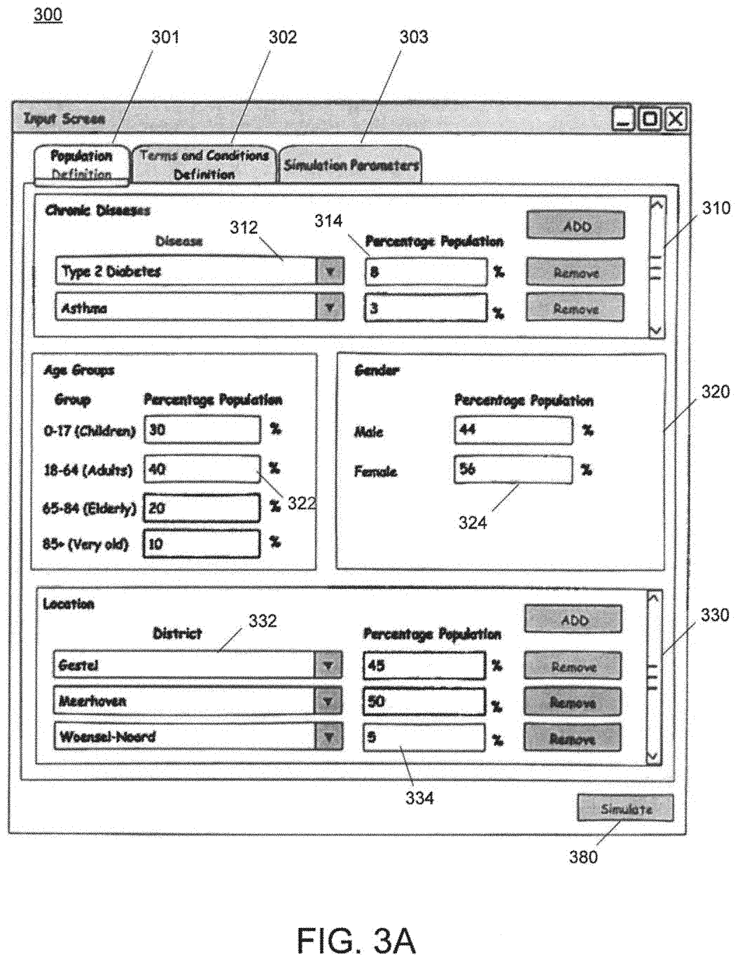

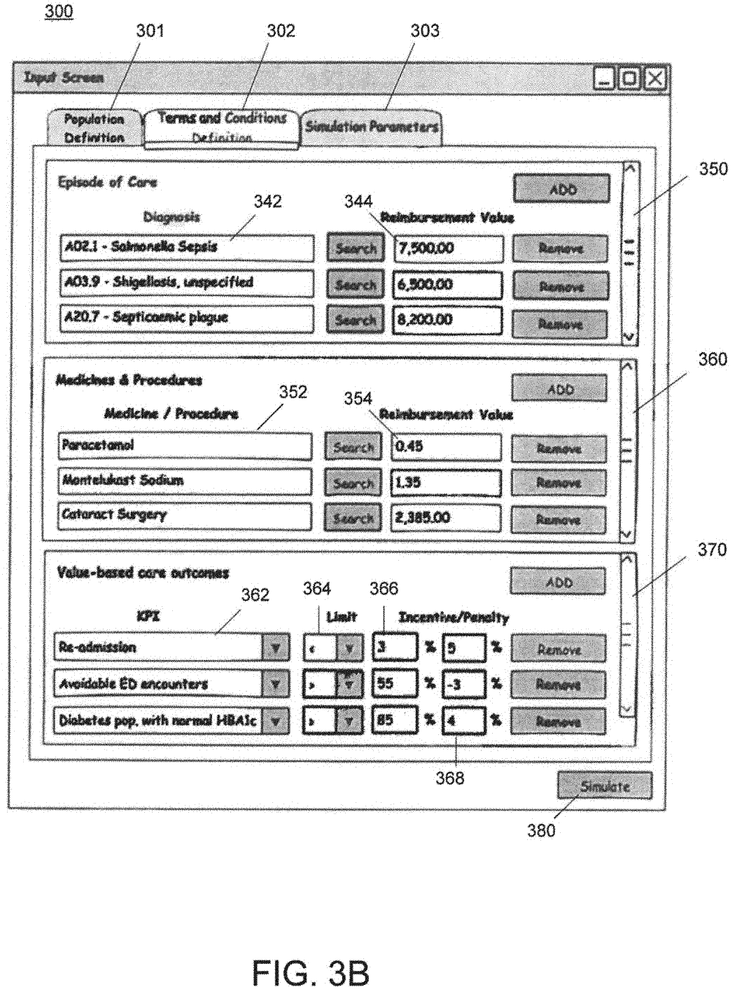

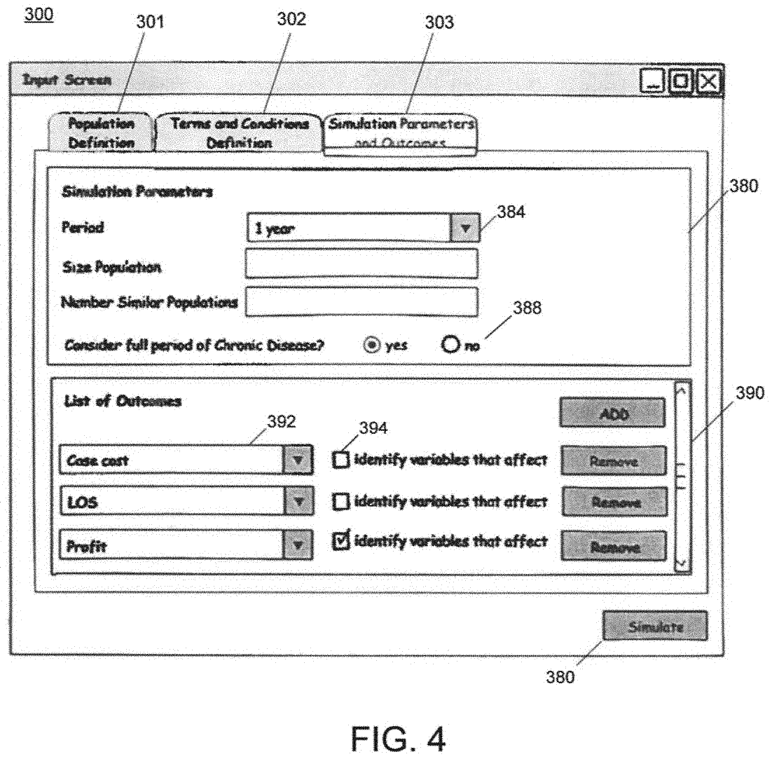

FIGS. 3A, 3B, and 4 show examples of a graphical user interface 300 for inputting information on a terminal for storage in the input stage 110 and subsequent input into the analysis engine 120 of the system. In this example, tabs 301, 302, and 303 may be selected to switch screens for receiving information for defining populations, information on terms and conditions of a proposed payer contract, and information defining one or more simulation parameters, outcomes to be simulated, and associated information.

FIG. 3A illustrates a screen for defining populations corresponding to tab 301. This screen includes a first section 310, a second section 320, and a third section 330. The first section 310 receives information on chronic diseases. Multiple fields 312 may be provided with corresponding drop down menus containing a list of diseases (e.g., displayed based on selected arrow buttons). In this example, fields 312 designate Type 2 Diabetes and Asthma. Additional windows 314 are provided to receive information indicating percentages of the population under consideration that have the aforementioned diseases. Selection keys may be provided to add, remove, or otherwise change information in the fields of the first section.

The second section 320 includes windows 322 for designating percentages of the population under consideration for different age groups and windows 324 for designating population by sex. In this example, the age group of 18-64 represents the largest percentage of the population under consideration (e.g., 40%), while the age group of 85 and older represents the smallest percentage (e.g., 10%). This or another window may also designate percentages of the population by gender.

The third section 330 includes fields 332 for receiving location (e.g., district) information correlated to population percentages entered in fields 334. This section may also include control buttons for adding or removing information in fields 332 and 334.

FIG. 3B illustrates a screen of a graphical user interface corresponding to tab 302, which includes a first section 350, a second section 360, and a third section 370. The first section 350 includes windows 342 and windows 344. The windows 342 receive information identifying a number of diagnoses along with corresponding insurance or HCO codes. In this example, three diagnoses are indicated: salmonella sepsis, shigellosis unspecified, and septicaemic plague. Fields 344 receive information indicating a reimbursement value corresponding to each of the diagnoses. In the first section, function buttons may be provided to help search for diagnoses and related codes, for example, through drop down lists associated with fields 342.

The second section 360 includes fields 352 and 354. Fields 352 receive information indicating medicine and procedures, e.g., paracetamol, montelukast sodium, cataract surgery. etc. Windows 354 receiving information indicating reimbursement values for respective ones of the medicine/procedures.

The third section 370 fields 362, 364, 366, and 368. Fields 362 receive information indicating KPIs, e.g., re-admission, avoidable ED encounters, and diabetes pop. with normal HBAIc. Fields 364 allow for a designation on any limits associated with the KPIs. Fields 366 may indicate thresholds of corresponding ones of the KPIs, and fields 368 may indicate incentives or penalties associated with corresponding ones of the KPIs. For example, as illustrated in FIG. 3B, if the Re-admission rate is less than 3%, then the HCO will receive an incentive of 5%. If the Avoidable ED encounters rate is greater than 55%, then the HCO will receive a penalty of 3%.

FIG. 4 illustrates a screen of a graphical user interface corresponding to tab 303, which includes a first section 380 and a second section 390. The first section 380 includes windows 384 for designating one or more simulation parameters and options 388 for considering whether the full period of a chronic disease is to be taken into consideration during the simulation. The second section 390 includes windows 392 for designating one or more outcomes to be simulated and options 394 for identifying variables that affect the outcomes in corresponding windows 392. The simulation is performed when the simulation button 380 is activated. When all or a portion of the fields are filled with information, the simulate button 380 may be selected to instruct the analysis engine 120 to generate corresponding outcome information based on the entered population definition, HCO data, and/or other information stored in the input stage 110.

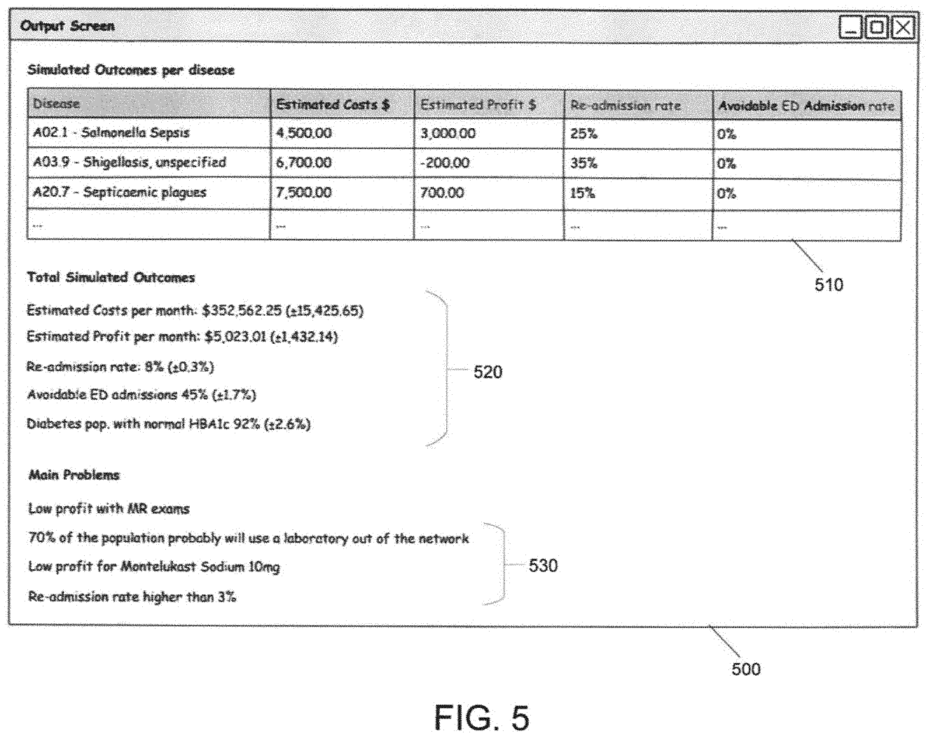

FIG. 5 shows an example of a graphical user interface 500 which the output stage 130 may use to output results of the analysis stage 120. The graphical user interface includes a screen having a first section 510, a second section 520, and a third section 530, with each section displaying different results of the analysis.

The first section 510 includes information indicating simulated outcomes for the diagnosed diseases specified in section 510 of FIG. 4. In this section, the following information is indicated for each disease as calculated by the analysis engine 120: Estimated Cost, Estimated Profit, Re-Admission Rate, and Avoidable ED Admission Rate. Each of these outcomes may provide an indication of areas of weakness and strength of the proposed payer contract in relation to the interests of the HCO. For example, such areas may identify areas where the contract terms and/or coverage may be improved for purposes of advancing the interests of the HCO in terms of patient care and costs.

The HCO may use this information to its advantage in negotiating changes to the proposed contract. For example, the estimate profit section for shigellosis unspecified indicates that the HCO will take a loss under the contract terms. SDMs of the HCO may use this information to negotiate an increased payment from the payer for this disease in order to improve profitability under the contract. Without the results produced by the analysis engine 120 of the present embodiments, the HCO SDMs would not have been able to determine this outcome under the contract, and thus would not be able to negotiate more favorable contract terms from the payer.

The second section 520 provides information indicating total simulated outcomes under the proposed payer contract, as determined by the analysis engine 120. These outcomes include estimated costs per month, estimated profit per month, re-admission rate (expressed as a percentage with a corresponding standard deviation), avoidable ED admissions (expressed as a percentage with a corresponding standard deviation), and diabetes population with normal HBA1c (also expressed as a percentage with a corresponding standard deviation). Like the information in first section 510, SDMs of the HCO may use the information in section 520 to negotiate more favorable contract terms. Without the results produced by the analysis engine 120 of the present embodiments, the HCO SDMs would not have been able to identify what terms need to be improved during negotiations.

The third section 530 provides information indicating main problems that are expected to occur under the proposed payer contract. These problems include, under the contract being considered, a low profit expectation for magnetic resonance (MR) imaging exams, an estimate that 70% of the population will use a laboratory that increases costs (e.g., out-of-network labs close to their homes), a low profit for Montelukast Sodium 10 mg, and a re-admission rate higher than 3% for patients. Section 530 may also display information indicative of a confidence interval as calculated by the analysis engine 120. Like the information in the first and second sections 510 and 520, SDMs of the HCO may use the information in section 530 to negotiate more favorable contract terms. Without the results produced by the analysis engine 120 of the present embodiments, the HCO SDMs would not have been able to identify these weaknesses in the contract in relation to the interests of the HCO.

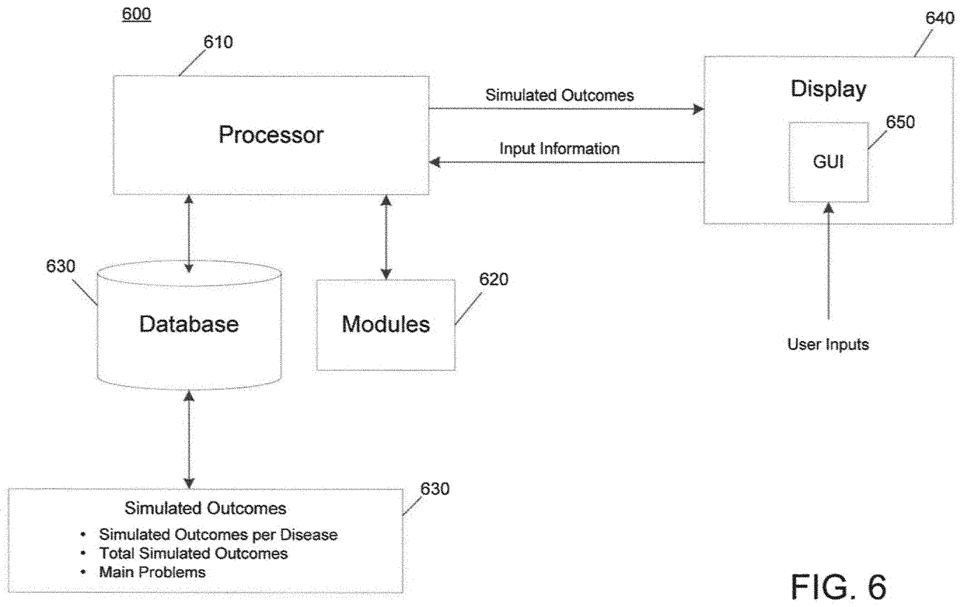

Referring to FIG. 6, a processing system 600 for implementing the embodiments described herein includes a processor 610, a machine-readable storage medium 620, a database 630, a display 640, and a graphical user interface 650. The processor 610 may be implemented in logic which, for example, may include hardware, software, or both. When implemented at least partially in hardware, the processor 610 may be, for example, any one of a variety of integrated circuits including but not limited to an application-specific integrated circuit, a field-programmable gate array, a central processing unit, a combination of logic gates, a system-on-chip, a microprocessor, or another type of processing or control circuit.

When implemented in at least partially in software, the processor 610 may include or be coupled to a memory or other storage device (e.g., medium 620) for storing code or instructions to be executed, for example, by a computer, processor, microprocessor, controller, or other signal processing device. The code or instructions may implement operations of analysis engine 120. In one embodiment, the code or instructions may also implement operations of one or more of the input states 110 and the analysis engine 120 as previously described. Because the algorithms that form the basis of the method embodiments (or operations of the computer, processor, microprocessor, controller, or other signal processing device) are described in detail, the code or instructions for implementing the operations of the method embodiments may transform the computer, processor, controller, or other signal processing device into a special-purpose processor for performing the operations and methods of the embodiments described herein.

The machine-readable storage medium 620 stores instructions for controlling the processor 610 to perform some or all of the operations of the method and system embodiments described herein. In this case, the stages and/or other features (e.g., as set forth in FIG. 1) may be implemented in any of the forms of logic (software, hardware, or a combination) herein.

The database 630 stores various forms of information including information received from the input stage 110. This information may be input, for example, using a graphical user interface (GUI) implemented by processor 610 and visible on the display 640. For example, the aforementioned screens illustrated in FIGS. 3, 4, and 5 may be output on the GUI. Information received through the GUI (e.g., from an SDM or other user) may be input into the processor 610 for use by the analysis engine 120. This information may also be stored in the database 630, along with the processing results generated by the analysis engine 120. These results are conceptually shown in box 630 to include simulated outcomes per disease, total simulated outcomes, main problems, and/or other results generated by the analysis engine.

The database 630 may be or include a centralized database, a decentralized database (e.g., blockchain), or a storage network of databases respectively storing patient data, insurance claim data, socio-economic data, cost data, and/or other information used herein. In one embodiment, the database 630 may be at least partially implemented in a cloud-based network.

In operation, the instructions stored in the machine-readable medium 620 controls the processor 610 to perform the operations of the method and system embodiments described herein. The processor may receive inputs from one or more users, applications, and/or control software during this time to control, change, or implement some of these operations. The results of the processor 610, including a designation of cost, profit, and patient care outcomes, may be displayed on the display 640.

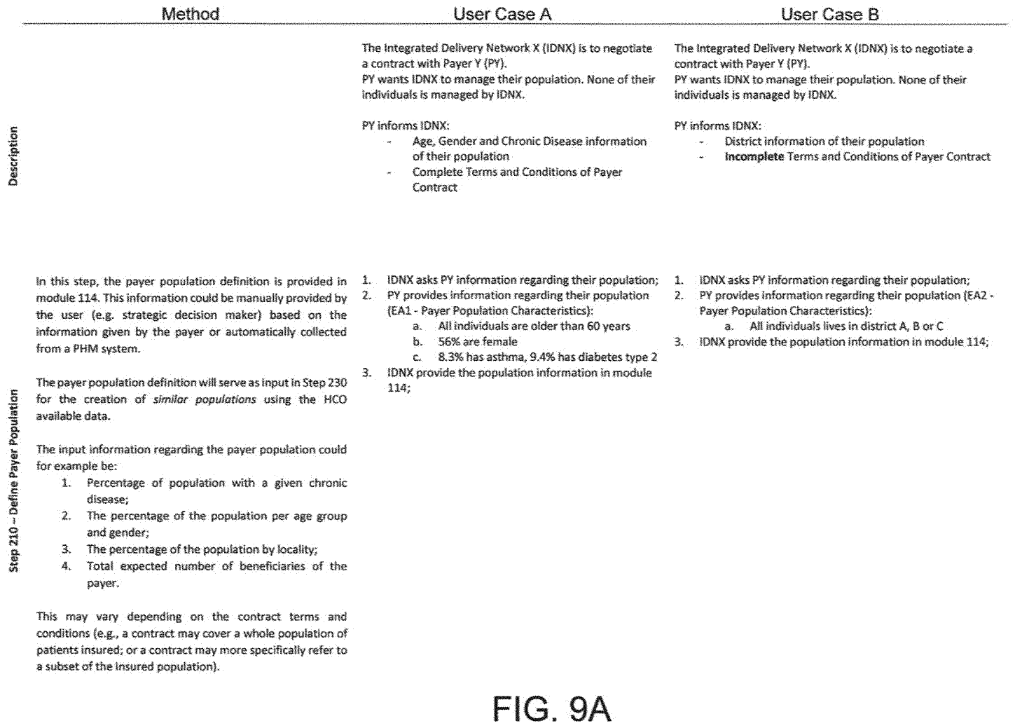

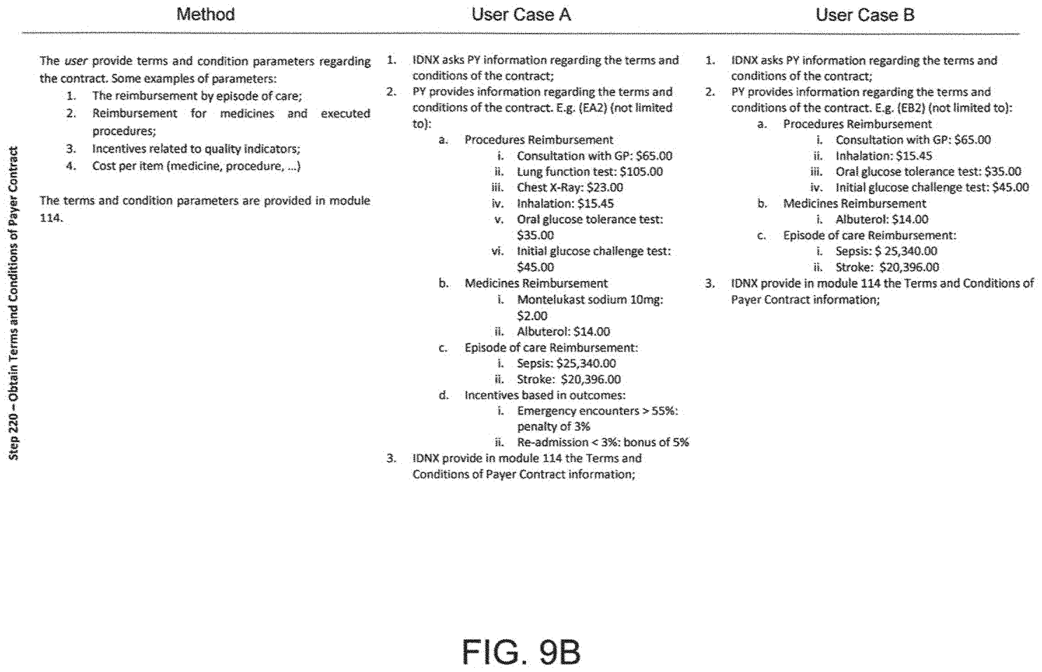

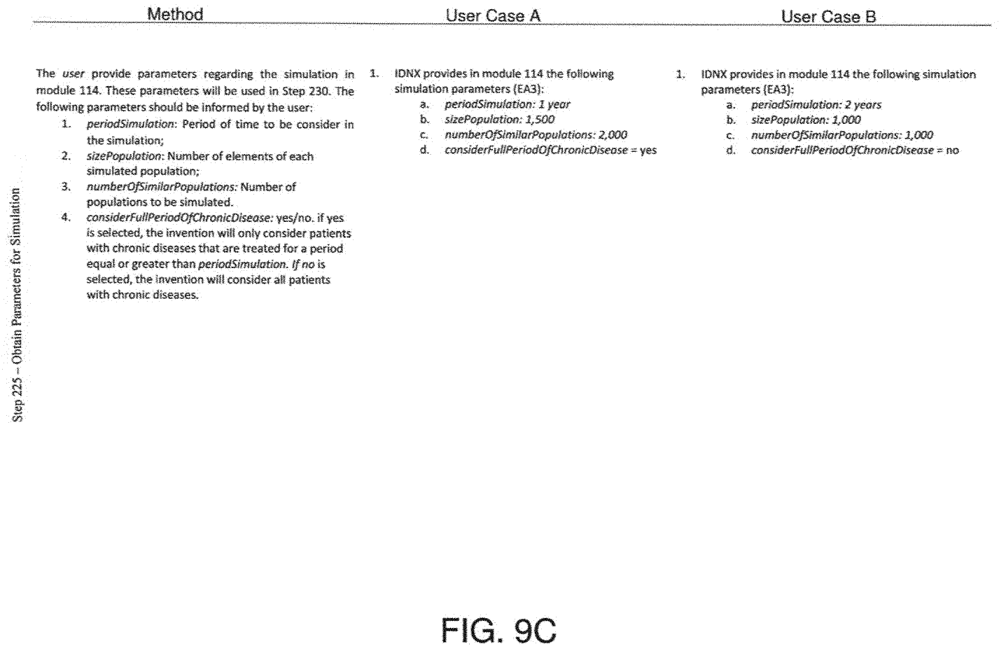

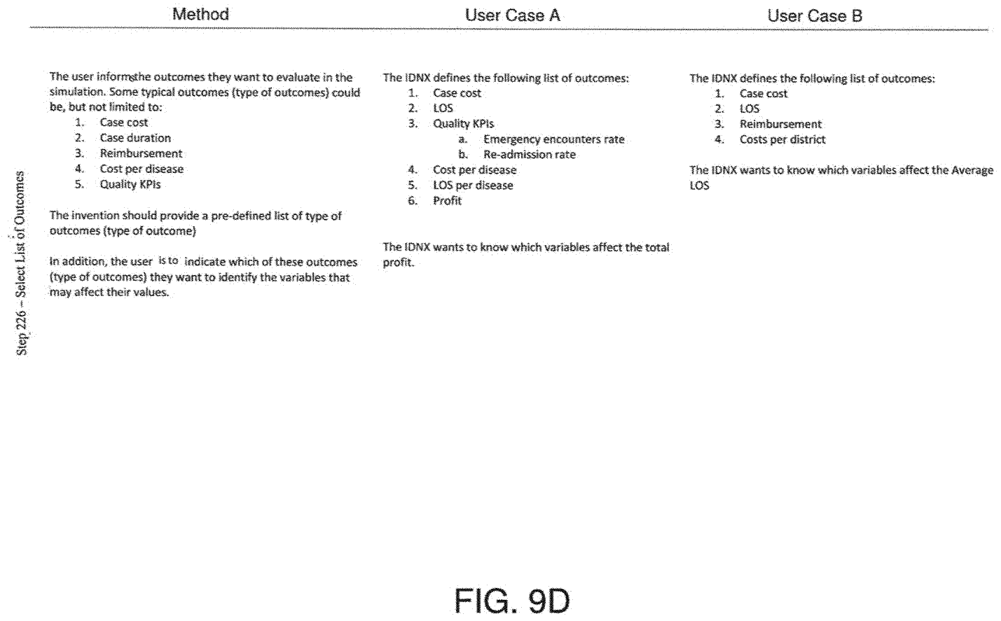

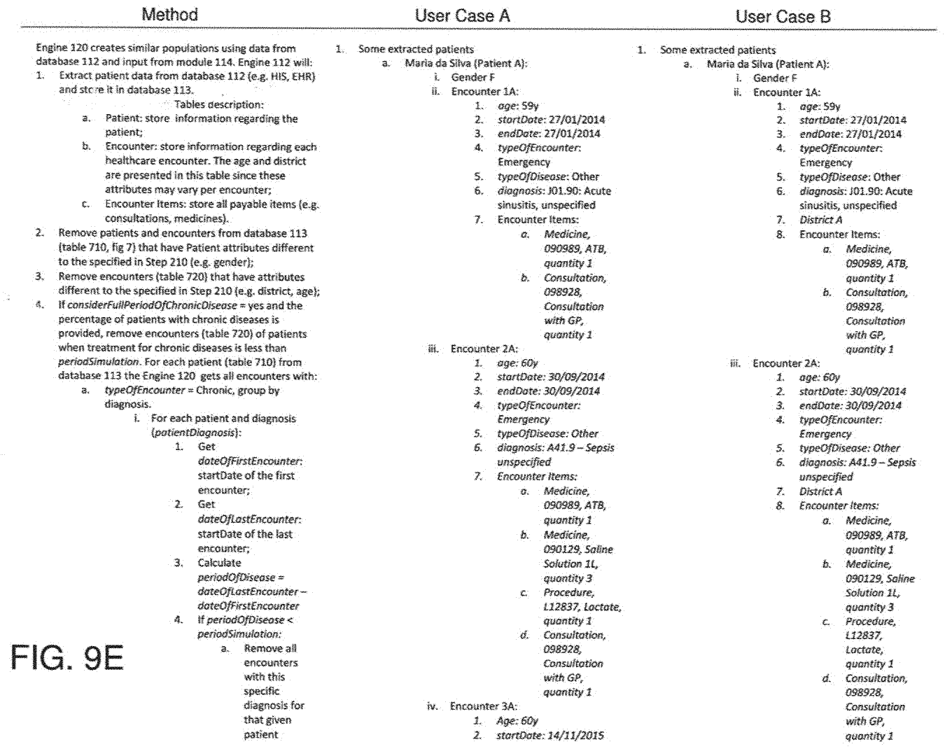

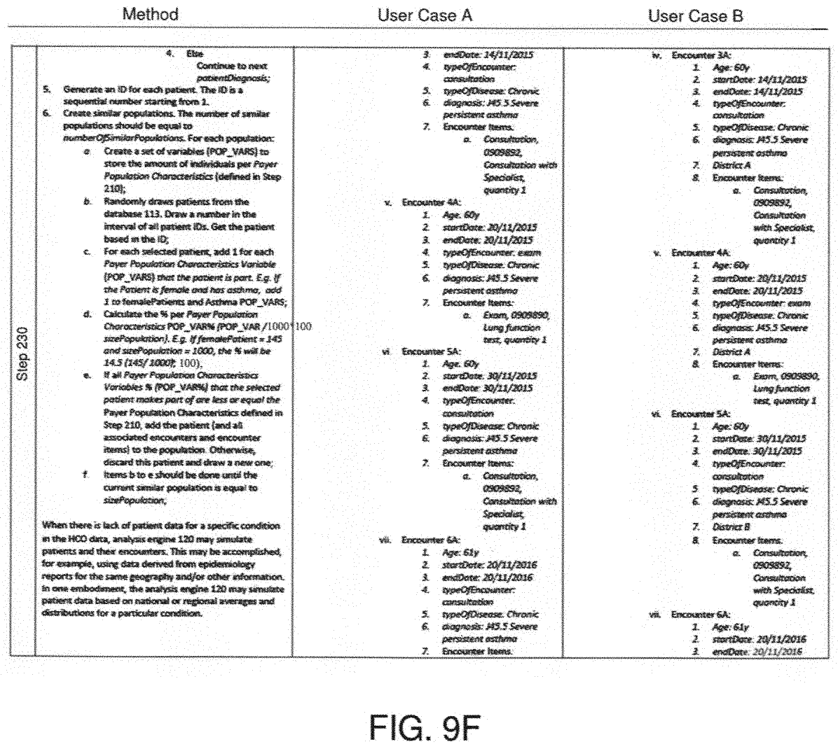

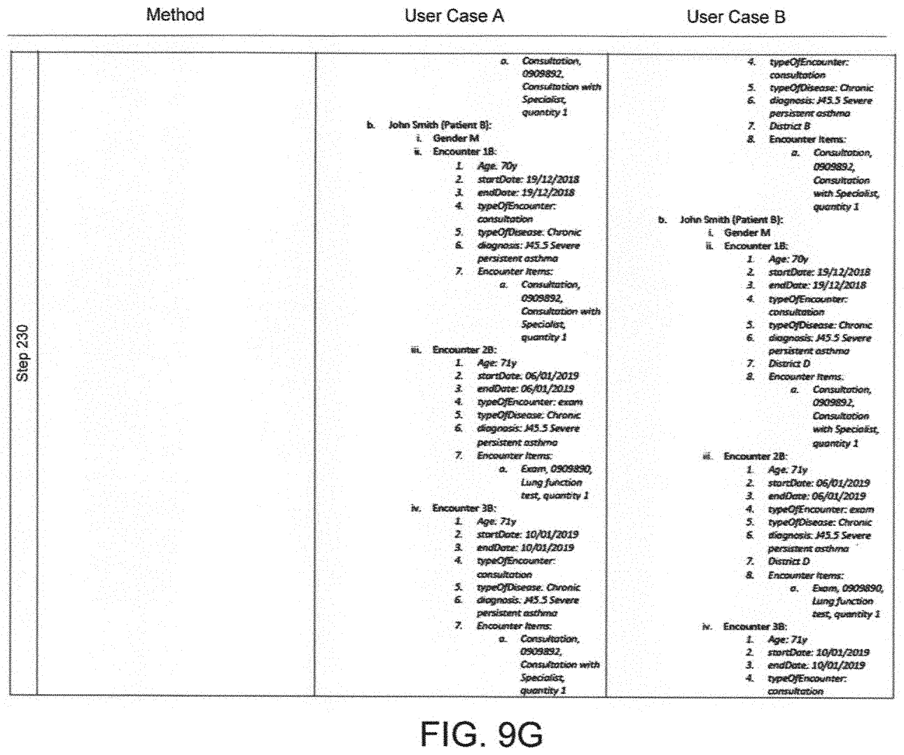

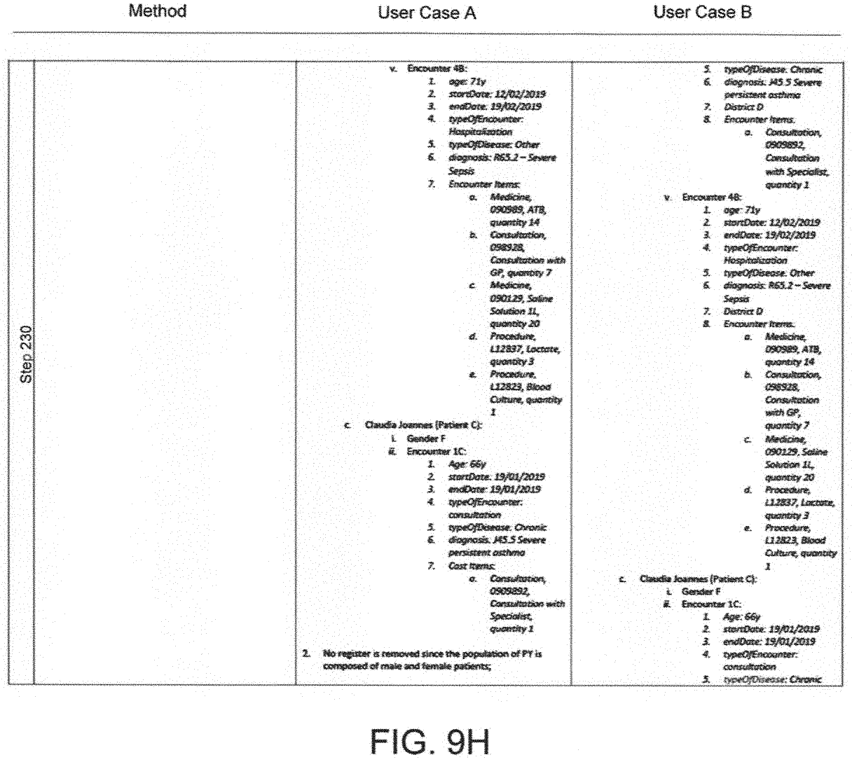

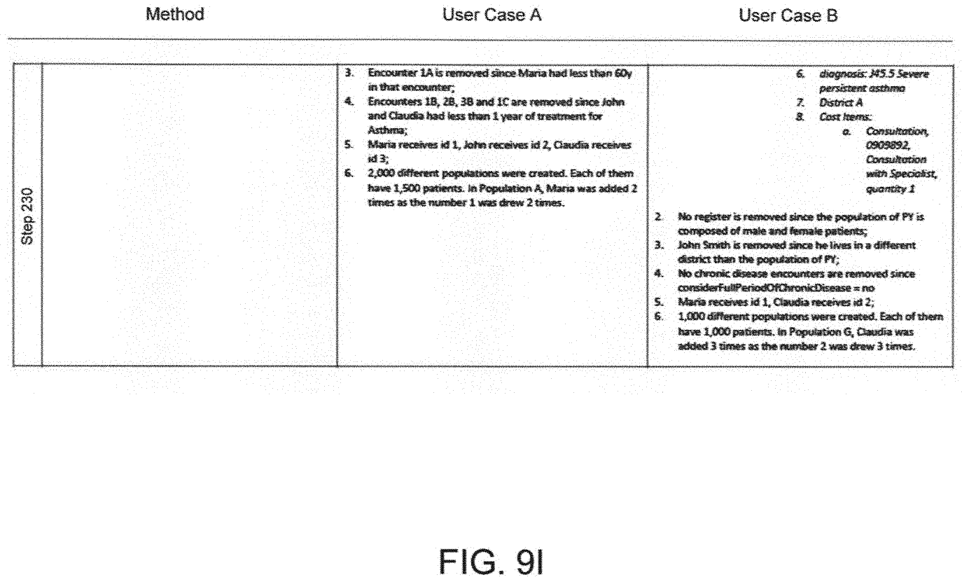

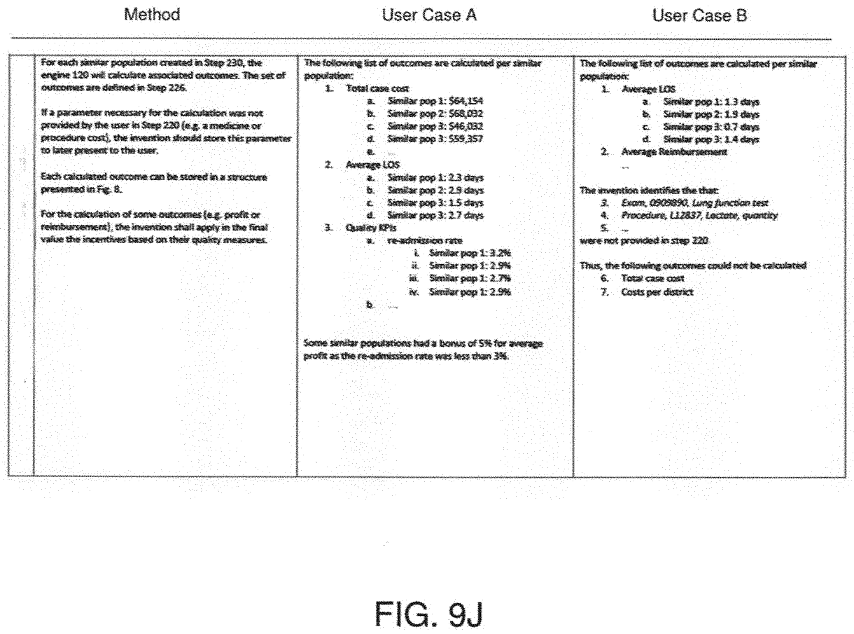

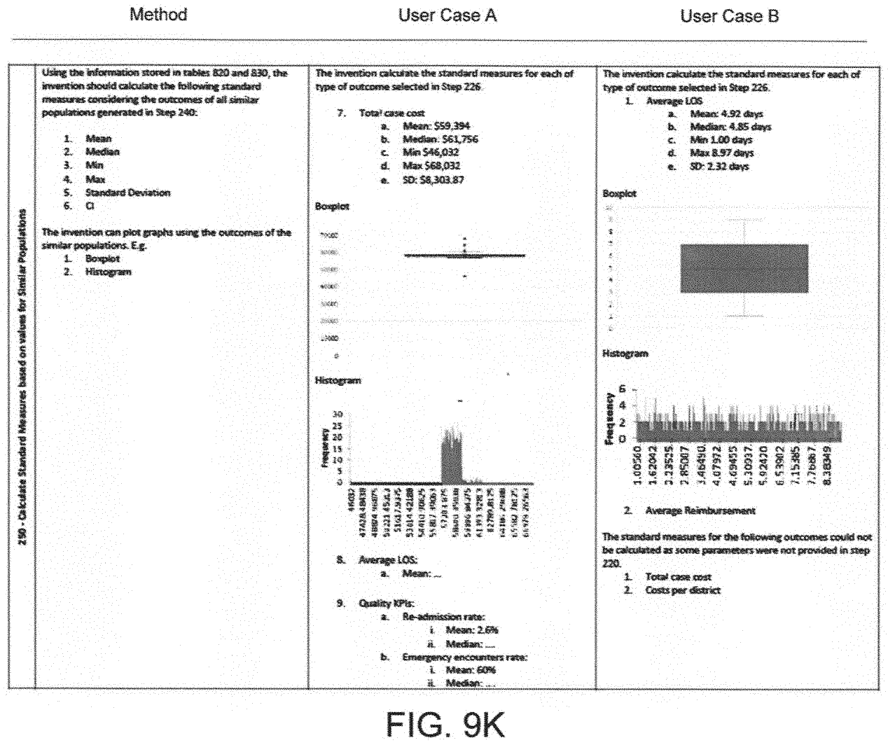

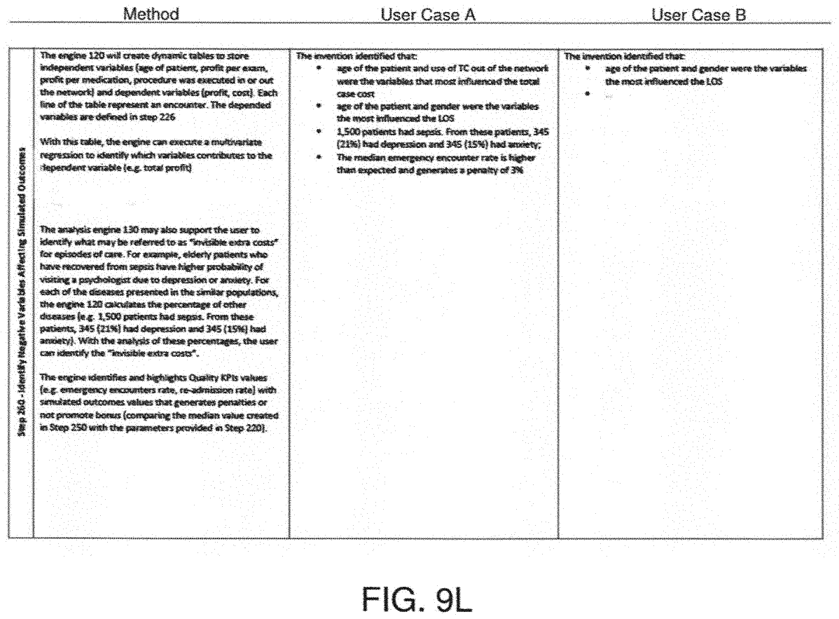

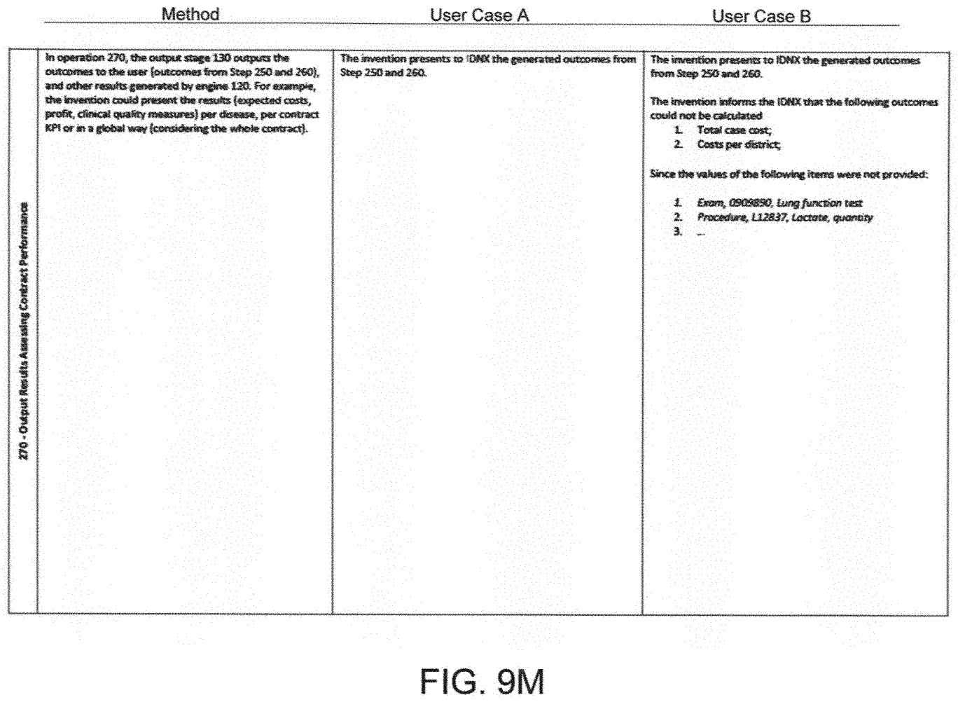

FIGS. 9A to 9M show application of the method embodiment of FIG. 2 to two use cases, one for a user case A and one for user case B. The user cases are different, for example, in terms of the type and amount of information a payer (Y) provides an integrated delivery network X (IDNX). The user cases may also differ based on the terms and conditions of the payer contract IDNX is negotiating with payer Y. Based on these and other differences indicated in the figures, different outcomes are provided for the payer contract, which outcomes may provide a basis upon which IDNX may determine whether to re-negotiate some terms in the contract and/or accept or reject the contract.

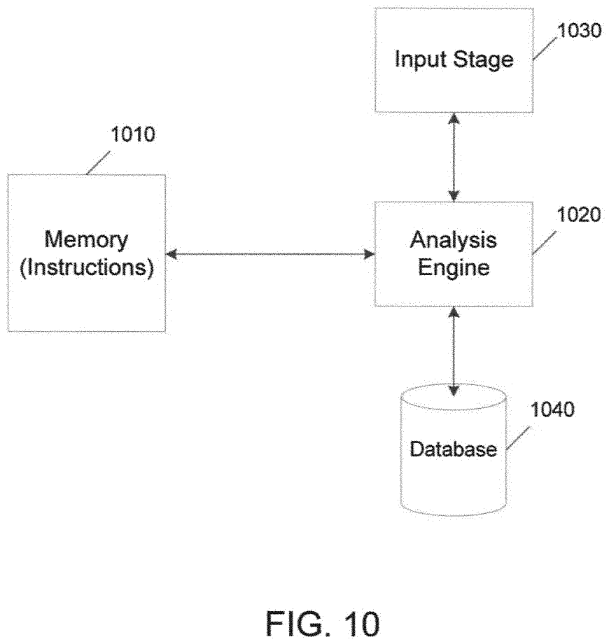

FIG. 10 illustrates an example of a system for managing healthcare information which includes a storage device 1010 to store instructions and an analysis engine 1020 configured to execute the instructions to perform the operations of the system and method embodiments described herein. The storage device may be a non-transitory computer-readable medium, a random access memory, or another type of storage device. The analysis engine 1020 may receive information from an input stage 1030 and database 1040. The analysis engine 1020 and the other features illustrated in FIG. 10 may corresponds to those, for example, in FIG. 1.

The methods, processes, and/or operations described herein may be performed by code or instructions to be executed by a computer, processor, controller, or other signal processing device. The code or instructions may be stored in a non-transitory computer-readable medium in accordance with one or more embodiments. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods herein.

The modules, stages, models, algorithms, engines, processors, and other information generating, processing, and calculating features of the embodiments disclosed herein may be implemented in logic which, for example, may include hardware, software, or both. When implemented at least partially in hardware, the modules, stages, models, algorithms, engines, processors, and other information generating, processing, and calculating features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the modules, stages, models, algorithms, engines, processors, and other information generating, processing, and calculating features may include, for example, a memory or other storage device for storing code or instructions to be executed, for example, by a computer, processor, microprocessor, controller, or other signal processing device. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods herein.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any blocks and block diagrams herein represent conceptual views of illustrative circuitry embodying the principles of the invention. Implementation of particular blocks can vary while they can be implemented in the hardware or software domain without limiting the scope of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method for managing healthcare information, comprising:
selecting a type of outcome under a payer contract with a healthcare organization (HCO);
generating a set of similar populations based on information including HCO data;
calculating outcomes for the similar populations in the set based on terms and conditions of the payer contract, the outcomes calculated using a simulation algorithm;
calculating performance measures for the calculated outcomes; and
outputting the performance measure with the calculated outcomes to identify a best outcome under the payer contract for one or more parameters.

2. The method of claim 1, wherein generating the set of similar populations includes:
filtering and pre-processing the HCO data; and
randomly selecting HCO patients until one or more constraints of a payer population are satisfied.

3. The method of claim 1, further comprising:
defining parameters for the simulation algorithm used to calculate the outcomes.

4. The method of claim 1, wherein the type of outcome is one of case cost, case duration, reimbursement, cost per disease, and quality KPIs.

5. The method of claim 1, further comprising:
filtering the HCO data prior to generating the set of similar populations,
wherein the HCO data is included in categories which include patient data, encounter data, and encounter items.

6. The method of claim 1, further comprising:
performing a multivariable regression analysis based on at least one independent variable and at least one dependent variable, wherein results of the multivariable regression analysis indicates one or more attributes that contributed to a worst one of the calculated outcomes.

7. The method of claim 1, further comprising:
relating simulated quality outcomes to expected values in the contract.

8. The method of claim 1, further comprising:
calculating invisible extra costs for a plurality of episodes of care.

9. The method of claim 1, further comprising:
generating graphical representations of the outcomes; and
displaying the graphical representations.

10. The method of claim 1, further comprising:
receiving the information of the proposed payer contract and the HCO data through different fields of a screen displayed on a graphical user interface.

11. A system for managing healthcare information, comprising:
a storage device to store instructions; and
an analysis engine configured to simulate performance under a payer contract with a healthcare organization (HCO), the analysis engine which executes the instructions to:
select a type of outcome to be evaluated under the payer contract;
generate a set of similar populations based on information including HCO data;
calculate outcomes for the similar populations in the set based on terms and conditions of the payer contract, the outcomes calculated using a simulation algorithm;
calculate performance measures for the calculated outcomes; and
output the performance measure with the calculated outcomes to identify a best outcome under the payer contract for one or more parameters.

12. The system of claim 11, wherein the analysis engine is configured to perform the following in order to generate the set of similar populations:
filtering and pre-processing the HCO data; and
randomly selecting HCO patients until one or more constraints of a payer population are satisfied.

13. The system of claim 11, wherein the analysis engine is configured to define parameters for the simulation algorithm used to calculate the outcomes.

14. The system of claim 11, wherein the type of outcome is one of case cost, case duration, reimbursement, cost per disease, and quality KPIs.

15. The system of claim 11, wherein the analysis engine is configured to filter the HCO data before the set of similar populations are generated, and wherein the HCO data is included in categories which include patient data, encounter data, and encounter items.

16. The system of claim 11, wherein the analysis engine is configured to perform a multivariable regression analysis based on at least one independent variable and at least one dependent variable, and wherein results of the multivariable regression analysis indicates one or more attributes that contributed to a worst one of the calculated outcomes.

17. The system of claim 11, wherein the analysis engine is configured to calculate invisible extra costs for a plurality of episodes of care.

18. The system of claim 11, wherein the analysis engine is configured to generate graphical representations of the outcomes and display the graphical representations.
